(19) United States
(12) Patent Application Publication
(10) Pub. No.: US 2026/0205327 A1
(43) Pub. Date: Jul. 16, 2026

(54) EFFICIENTLY TRANSMITTING A SET OF SAMPLES TO ANOTHER DEVICE

(71) Applicant: Lenovo (Singapore) Pte. Limited, Singapore (SG)

(72) Inventors: Vahid Pourahmadi, München (DE); Venkata Srinivas Kothapalli, Aurora, IL (US); Ahmed Hindy, Aurora, IL (US); Vijay Nangia, Woodridge, IL (US)

(73) Assignee: Lenovo (Singapore) Pte. Limited, Singapore (SG)

(21) Appl. No.: 19/129,572

(22) PCT Filed: Nov. 13, 2023
(86) PCT No.: PCT/IB2023/061453

§ 371 Date: May 13, 2025

Related U.S. Application Data
(60) Provisional application No. 63/425,162, filed on Nov. 14, 2022.

(51) Int. Cl. H04L 25/02; G06N 3/0455

(52) U.S. Cl. CPC H04L 25/0254; G06N 3/0455

(57) ABSTRACT

Various aspects of the present disclosure relate to an artificial intelligence/machine learning (AI/ML) model that facilitates transmitting channel state information (CSI) feedback to a network entity. In one or more implementations, the AI/ML model includes one or more neural networks implemented at a user equipment to encode CSI feedback, and one or more neural networks implemented at a network entity to decode the encoded CSI feedback. A set of samples, such as training data to train the AI/ML model, is obtained that are based on an input to the AI/ML model and an expected output from the AI/ML model. A collection of samples in the set are grouped together and a single sample representing the collection of samples is determined. A reduced set of samples is determined that includes the single sample rather than the collection of samples, and this reduced set of samples is transmitted to a network entity.

### RELATED APPLICATION

This application claims priority to U.S. Patent Application Ser. No. 63/425,162 filed Nov. 14, 2022 entitled “EFFICIENTLY TRANSMITTING A SET OF SAMPLES TO ANOTHER DEVICE,” the disclosure of which is incorporated by reference herein in its entirety.

### TECHNICAL FIELD

The present disclosure relates to wireless communications, and more specifically to efficiently transmitting a set of samples.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In the wireless communications system, channel state information (CSI) feedback can be transmitted from a UE to a base station (e.g., a gNB). The CSI feed provides the base station with an indication of the quality of a channel at a particular time.

### SUMMARY

The present disclosure relates to methods, apparatuses, and systems that support efficiently transmitting a set of samples to another device. An artificial intelligence/machine learning (AI/ML) model is implemented to facilitate transmitting CSI feedback to a network entity. In one or more implementations, the AI/ML model includes one or more neural networks implemented at a UE to encode CSI feedback (e.g., which reduces reduce the number of bits used to transmit the CSI feedback), and one or more neural networks implemented at a network entity (e.g., a base station) to decode the encoded CSI feedback. A set of samples, such as training data to train or retrain the AI/ML model, is obtained that are based on an input to the AI/ML model and an expected or desired output from the AI/ML model. In one or more implementations, a collection of samples in the set are grouped together and a single sample representing the collection of samples is determined. A reduced set of samples is determined that includes the single sample rather than the collection of samples, and this reduced set of samples is transmitted to a network entity. By using the reduced set of samples, the amount of data that is transmitted to the network entity is reduced while having little to no affect on the accuracy of the trained of the AI/ML model.

Some implementations of the method and apparatuses described herein may further include to: obtain a first set of information that includes a set of samples, wherein each sample includes at least one of a first component and a second component, and wherein the first component is based at least in part on an input to an artificial intelligence/machine learning model and the second component is based at least in part on an expected output of the artificial intelligence/machine learning model; generate, using a function, a second set of information based at least in part on at least one of the first component or the second component; transmit, to a network entity, a first signaling indicating a third set of information generated based at least in part on at least one of the first set of information and the second set of information.

In some implementations of the method and apparatuses described herein, the samples in the set of samples are based at least in part on a channel data representation during a first time-frequency-space region. Additionally or alternatively, the method and apparatuses further include to receive, from another device, a second signaling indicating the first set of information. Additionally or alternatively, the function is received from or configured by another device. Additionally or alternatively, the function assigns an importance value and a weight to samples of at least a representation of the first set of information and the method and apparatus further include to generate the second set of information based on whether the importance value is larger than a predetermined threshold. Additionally or alternatively, the function is based on at least geometric properties of at least one of the first component or the second component. Additionally or alternatively, the function is based on at least joint geometric properties of the first component and the second component. Additionally or alternatively, the function is based on at least a fourth set of information that includes a set of samples of at least one of the first component and the second component where the first component and the second component are based on an input and an expected output of an additional artificial intelligence/machine learning model. Additionally or alternatively, the function is based on a statistical similarity of the samples of the first set of information and the fourth set of information. Additionally or alternatively, the fourth set of information includes a set of channel data representations during a time-frequency-space region and are used to train the artificial intelligence/machine learning model. Additionally or alternatively, the function is based on a neural network block that is determined based on a set of parameters including a structure of the neural network or weights of the neural network where the output of the neural network block is used to determine at least the importance value and the weight of the samples. Additionally or alternatively, an input of the neural network block is based on at least one of the first component or the second component. Additionally or alternatively, an output of the neural network block is based on at least one of the first component or the second component. Additionally or alternatively, the method and apparatuses further include to receive, from another device, a second signaling indicating the set of parameters. Additionally or alternatively, the representation of the first set of information is based on at least an embedding neural network block defined based on a set of information related to a structure and weights of the neural network block. Additionally or alternatively, the method and apparatuses further include to receive, from another device, a second signaling indicating the set of information related to the structure and weights of the neural network block. Additionally or alternatively, samples in the second set of information include at least a subset of the first set of information and weights associated with samples of the first set of information. Additionally or alternatively, the third set of information includes an additional set of samples, wherein each sample in the additional set of samples includes at least one of the first component, the second component, and a third component, and wherein the third component represents a weight of the sample. Additionally or alternatively, the third set of information includes information related to a model, and wherein the model is determined to generate samples with similar statistics to at least one of the first set of information or the second set of information. Additionally or alternatively, the model is a neural network block and the third set of information includes information related to at least one of a structure and weights of the neural network block. Additionally or alternatively, the method and apparatuses further include to determine a first neural network block and a second neural network block representing an encoding and a decoding side of a two-sided model. Additionally or alternatively, the method and apparatuses further include to receive, from another device, a second signaling indicating parameters used for determination of at least the first neural network block and the second neural network block. Additionally or alternatively, the function assigns an importance value and a weight to samples of the first set of information and the method and apparatuses further include to generate the second set of information based at least in part on whether the importance value is larger than a predetermined threshold. Additionally or alternatively, the function is based on at least a difference or gradient associated with the second component and an output of the two-sided model based on the first component. Additionally or alternatively, the function generates samples of the second set of information including at least one of the first component, the second component, and associated weights such that a weighted gradient average corresponding to the generated samples is close to an average gradient corresponding to samples of the first set of information.

Some implementations of the method and apparatuses described herein may further include to: receive, from a first device, a first signaling indicating a first set of information that includes a set of samples, wherein each sample includes at least one of a first component, a second component, and a third component, and wherein the first component and the second component are based on an input and an expected output of an artificial intelligence/machine learning model and the third component represents a weight of the sample; and generate a first set of parameters for at least a first neural network based on the first set of information, wherein the first set of parameters includes a structure of the first neural network or weights of the first neural network.

In some implementations of the method and apparatuses described herein, the samples in the set of samples are based at least in part on a channel data representation during a first time-frequency-space region. Additionally or alternatively, a function used to determine the first set of information assigns an importance value and a weight to samples of at least a representation of a second set of information. Additionally or alternatively, a function used to determine the first set of information is based on at least geometric properties of at least one of the first component or the second component. Additionally or alternatively, a function used to determine the first set of information is based on at least joint geometric properties of the first component and the second component. Additionally or alternatively, a function used to determine the first set of information is based on at least a second set of information that includes a set of samples of at least one of the first component and the second component where the first component and the second component are based on an input and an expected output of an additional artificial intelligence/machine learning model. Additionally or alternatively, a function used to determine the first set of information is based on a statistical similarity of the samples of the first set of information and the second set of information. Additionally or alternatively, the second set of information includes a set of channel data representations during a time-frequency-space region and are used to train the artificial intelligence/machine learning model. Additionally or alternatively, a function used to determine the first set of information is based on a neural network block that is determined based on a second set of parameters including a structure of the neural network or weights of the neural network where the output of the neural network block is used to determine at least an importance value and the weight of the samples. Additionally or alternatively, an input of the neural network block is based on at least one of the first component or the second component. Additionally or alternatively, an output of the neural network block is based on at least one of the first component or the second component.

### BRIEF DESCRIPTION OF THE DRAWINGS

FIG. 1 illustrates an example of a wireless communications system that supports efficiently transmitting a set of samples to another device in accordance with aspects of the present disclosure.

FIG. 2 illustrates an example of a wireless communications system that supports efficiently transmitting a set of samples to another device in accordance with aspects of the present disclosure.

FIG. 3 illustrates an example of a two-sided model that supports efficiently transmitting a set of samples to another device in accordance with aspects of the present disclosure.

FIG. 4 illustrates an example of a wireless communications system that supports efficiently transmitting a set of samples to another device in accordance with aspects of the present disclosure.

FIGS. 5 and 6 illustrate an example of a block diagram of a device that supports efficiently transmitting a set of samples to another device in accordance with aspects of the present disclosure.

FIGS. 7 through 11 illustrate flowcharts of methods that support efficiently transmitting a set of samples to another device in accordance with aspects of the present disclosure.

### DETAILED DESCRIPTION

An AI/ML model facilitates transmitting CSI feedback from a UE to a network entity (e.g., a base station). In one or more implementations, the AI/ML model includes one or more neural networks implemented at the UE to encode CSI feedback (to reduce the number of bits used to transmit the CSI feedback), and one or more neural networks implemented at the network entity to decode the encoded CSI feedback. These neural networks are trained (or retrained) using training data that includes multiple samples, each sample including an input to the AI/ML model and an expected or desired output from the AI/ML model. These samples are transmitted (e.g., from the UE to the network entity) so that the neural networks at the UE and the network entity are trained using the same training data. Oftentimes multiple samples in the training data are similar (e.g., having similar inputs and outputs). This results in multiple similar samples of training data being transmitted from the UE to the network entity.

The techniques discussed herein leverage the observation that not all samples (e.g., training data samples) are equally important in training of an AI/ML model. For example, some samples might be redundant or might not be very informative or have high cross-correlation considering the samples that have already been observed by the AI/ML model. The UE (or another node or device generating the training data) reduces the redundancy in samples by removing similar samples, resulting in a reduced set of samples that is transmitted to a network entity.

In one or more implementations, the UE also associates a weight (or alternatively a rate-of-occurrence parameter or a probability value or a quantization thereof) to each or a group of the samples. For example, there may be 10 similar samples, and the techniques discussed herein can transmit an indication of one sample with a weight of 10 to indicate that there are 10 total samples similar to the one sample. This reduces the amount of data that is transmitted from the UE to the network entity because the UE transmits the one sample and an indication of a weight of 10 rather than transmitting all 10 samples.

By generating the reduced set of samples, the amount of data that the UE transmits to the network entity is reduced (which reduces communication overhead and delay in transmitting the training data) while having little to no affect on the training of the AI/ML model. Given the similarity of the samples that the UE did not transmit to the samples that the UE did transmit, any neural network blocks at the network entity can be trained (or retrained) and result in trained neural network blocks that are the same (or very similar) to neural network blocks trained using all of the training data. Furthermore, in situations in which the training data is stored for later usage, the reduced set of samples can be stored, thereby reducing storage space requirements.

Aspects of the present disclosure are described in the context of a wireless communications system. Aspects of the present disclosure are further illustrated and described with reference to device diagrams and flowcharts.

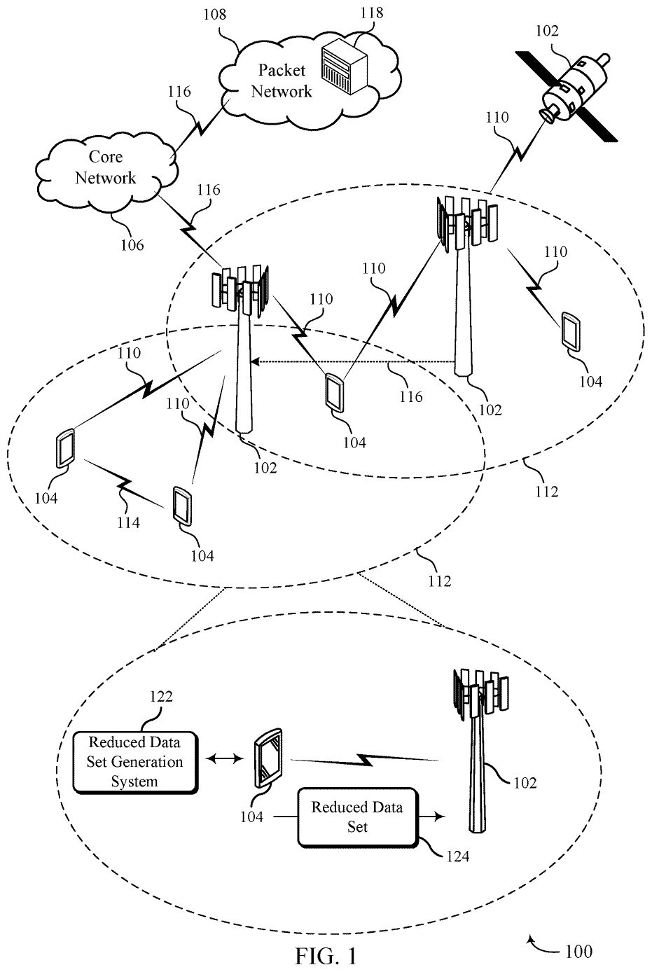

FIG. 1 illustrates an example of a wireless communications system 100 that supports efficiently transmitting a set of samples to another device in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHZ), FR4 (52.6 GHz-114.25 GHZ), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The UE 104 includes a reduced data set generation system 120 that generates a reduced data set 124 that is transmitted to the network entity 102. The reduced data set generation system 120 receives a set of samples, such as training data samples to train or retrain an AI/ML model. The reduced data set generation system 122 reduces the redundancy in the set of samples by removing similar samples and associating a weight (or alternatively a rate-of-occurrence parameter or a probability value or a quantization thereof) to each or a group of the set of samples, resulting in the reduced data set 124. For example, there may be 15 similar samples, and the reduced data set generation system 122 includes in the reduced data set 124 an indication of one of those 15 samples with a weight of 15 to indicate that there are 14 additional samples similar to the one sample. This reduces the amount of data that is transmitted from the UE 104 to the network entity 102 because the UE 104 transmits the one sample and an indication of a weight of 15 rather than transmitting all 15 samples.

In one or more implementations, the UE 104 determines a first set of information that includes a set of samples (e.g., training data) where each sample includes at least one of a first component and a second component. The first component is (or is based on) an input to an AI/ML model, and the second component is (or is based on) an expected or desired output of the AI/ML model. A function is used to determine a second set of information (e.g., a reduced set of samples) based at least in part on at least one of the first component and the second component of the samples of the first set of information. A third set of information is determined (e.g., the reduced set of samples or a generative model) that is based at least in part on at least one of the first set of information and the second set of information. This third set of information is transferred to another device (e.g., a network entity 102).

Although the discussions herein refer to the UE 104 as including the reduced data set generation system 122, additionally or alternatively another device or node in the wireless communications system 100 includes the reduced data set generation system 122. In such situations, this other device or node in the wireless communications system 100 transmits or otherwise provides the reduced data set generation system 122 to the UE 104.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

FIG. 2 illustrates an example of a wireless communications system 200 that supports efficiently transmitting a set of samples to another device in accordance with aspects of the present disclosure. The wireless communications system 200 includes a network entity 102 (e.g., a gNB) represented by node B₁ equipped with M antennas and K UEs 104 denoted by U₁, U₂, . . . , U_{K} each of which has N antennas.

$${H}_{l}^{k} ( t )$$

denotes a channel at time t over frequency band (or subcarrier or subband or physical resource block (PRB) or sub-PRB or PRB-group or bandwidth part in a channel bandwidth) l, l∈{1, 2, . . . , L}, between B₁ and Uₖ which is a matrix of size N×M with complex entries, e.g.,

$${H}_{l}^{k} ( t ) ∈ {ℂ}^{N \times M} .$$

At time t and frequency band l, the network entity 102 can be configured to transmit a message

$${x}_{l}^{k} ( t )$$

to user Uₖ where k={1, 2, . . . , K} while the network entity 102 uses

$${w}_{l}^{k} ( t ) ∈ {ℂ}^{M \times 1}$$

as the precoding vector. The received signal at Uₖ,

$${y}_{l}^{k} ( t ) ,$$

can be written as:

$${y}_{l}^{k} ( r ) = {H}_{l}^{k} ( t ) {w}_{l}^{k} ( t ) {x}_{l}^{k} ( t ) + {n}_{l}^{k} ( t )$$

where

$${n}_{l}^{k} ( t )$$

represents the noise vector at the receiver.

Further to the wireless communications system 200, to improve the achievable rate of the link, the network entity 102 can select

$${w}_{l}^{k} ( t )$$

that maximizes some metric such as the received signal to noise ratio (SNR). Several schemes have been proposed for optimal selection of

$${w}_{l}^{k} ( t )$$

where most of them utilize some knowledge about

$${H}_{l}^{k} ( t ) .$$

The network entity 102 can obtain information about

$${H}_{l}^{k} ( t )$$

by direct measurement (e.g., in time-division duplexing (TDD) mode and assuming reciprocity of the channel direct measurement of the uplink channel, in frequency-division duplexing (FDD) mode assuming reciprocity of some of the large scale parameters such as AoA/AoD), or indirectly using the information that the UE 104 sends to the network entity 102 (e.g., in FDD mode). In the latter case, a large amount of feedback may be needed to send accurate information about

$${H}_{l}^{k} ( t ) .$$

This becomes particularly important if there are a large number of antennas and/or large frequency bands.

In at least some aspects of the present disclosure, implementations consider a single time slot and focus on transmitting information regarding a channel between a user k and a network entity over multiple frequency bands. Further, implementations can utilize multiple time slots, such as by replacing a frequency domain with a time domain and/or creating a joint time-frequency domain. For purposes of the discussion herein

$${H}_{l}^{k} ( t )$$

may be denoted using

$${H}_{l}^{k} .$$

Further,

$${H}_{l}^{k} ( t )$$

may be defined as a matrix of size N×M×L which can be constructed by stacking

$${H}_{l}^{k}$$

for multiple frequency bands, e.g., the entries at H^{k}[n, m, l](t) are equal to

$${H}_{l}^{k} [ n , m , l ] ( t ) .$$

Thus, a UE may send information about N×M×L complex numbers to a network entity.

Several methods have been proposed trying to reduce the required CSI feedback. A group of these methods, usually referred to as two-sided methods, include two parts where the first part is deployed at the UE side and the second part is deployed at the network entity (e.g., gNB) side. The UE and network entity sides consist of a one or a few neural network (NN) blocks that are trained using data driven approaches. The UE side is responsible for computing a latent representation of the input data (what is to be transferred to the network entity) with a low number of bits (e.g., as low a number of bits as possible). Receiving what has been transmitted by the UE side, the network entity side reconstructs the information intended to be transmitted to the network entity.

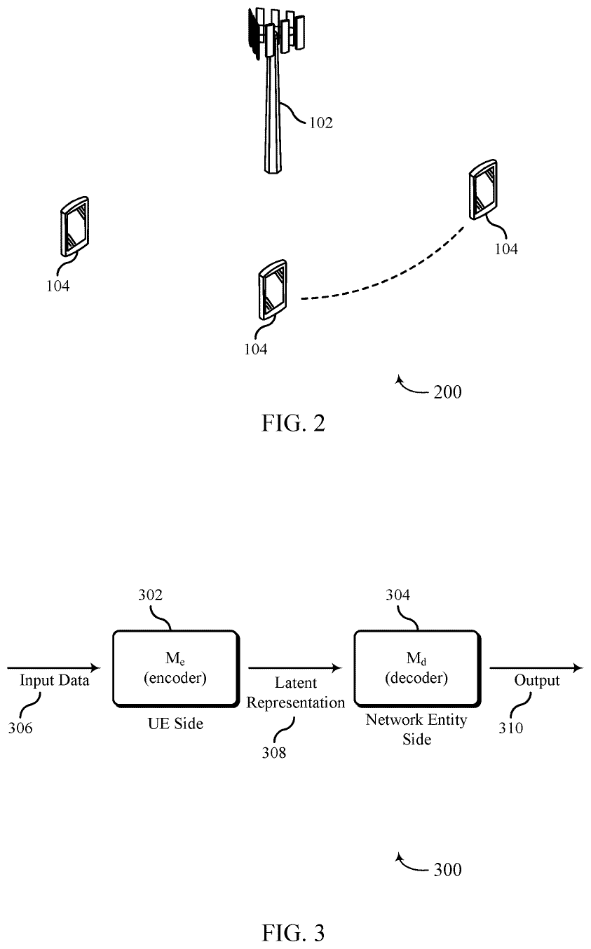

FIG. 3 illustrates an example of a two-sided model 300 that supports efficiently transmitting a set of samples to another device in accordance with aspects of the present disclosure. FIG. 3 illustrates a high-level structure of the two-sided model with a NN-based UE side 302, also referred to as Mₑ (encoding model), and a network entity side 304, also referred to as M_{d} (decoding model). The UE side 302 receives input data 306 and generates a latent representation 308 of the input data with a low number of bits (e.g., as low a number of bits as possible). The UE side 302 transmits the latent representation 308 to the network entity side 304, which reconstructs, as output 310, the information intended to be transmitted to the network entity side 304.

There are several methods to train the NN modules at the UE and network entity sides, including centralized training, simultaneous training, and separate training. Similarly, updating a two-sided model can be carried out centrally on one entity, on different entities but simultaneously, or separately. The training entity can be the UE itself, the network entity, a node at the UE side, or a node at the network entity side.

Training the model (e.g., the NN modules) uses a training dataset composed of different samples corresponding to the input and expected output of the system. Depending on the training scheme, the dataset may have samples for end to end mapping (e.g., input data and output), only encoder (e.g., input data and latent representation), or only decoder (e.g., laten representation and output). The training dataset may be created using samples from simulations, or samples collected from the actual environment.

Depending on the training entity, the training dataset (or collected samples) may be transferred to another node. For example, a set of samples may be transmitted from one entity to another. E.g., a training dataset for initial training may be transmitted, a training dataset for model update may be transmitted, a set of samples for model monitoring (e.g., model selection or model switching) may be transmitted, and so forth.

In such situations, the samples are to be transmitted efficiently, especially when the size of the set is large and there are constraints on the data transfer from one entity to another.

In the present disclosure, techniques for reducing the communication cost of transferring samples between different entities are discussed.

It should be noted that the techniques discussed herein are not limited to two-sided models and can be used for one-sided models as well (e.g., where the model only exists in the UE side). For example, in these cases, M_{d} can be assume as an identity network. Additionally, the techniques discussed herein are not limited to CSI feedback and can be used for situations in which training data or samples of the input data are transmitted. Furthermore, the techniques discussed herein are not limited to where the roles of the UE and network entity are reversed with a two-sided model, e.g., the encoder, Mₑ, model is performed at the network entity and the decoder, M_{d}, model is performed at the UE. Additionally, the samples can be collected at the UE and then transferred to the network entity or another node; or the reverse, e.g., samples are available at the network entity (or another entity) and then transmitted to the UE or a node at the UE side or another node.

In some wireless communications systems it is considered that a gNB is equipped with a two-dimensional (2D) antenna array with N₁, N₂ antenna ports per polarization placed horizontally and vertically, and communication occurs over N₃ PMI sub-bands. A precoding matrix indicator (PMI) subband consists of a set of resource blocks, each resource block consisting of a set of subcarriers. In such case, 2N₁N₂ CSI-RS ports are utilized to enable downlink channel estimation with high resolution for NR Rel. 15 Type-II codebook. In order to reduce the uplink (UL) feedback overhead, a Discrete Fourier transform (DFT)-based CSI compression of the spatial domain is applied to L dimensions per polarization, where L<N₁N₂. In the sequel the indices of the 2L dimensions are referred as the spatial domain (SD) basis indices. The magnitude and phase values of the linear combination coefficients for each sub-band are fed back to the gNB as part of the CSI report. The 2N₁N₂×N₃ codebook per layer l takes on the form:

$${W}_{l} = {W}_{1} {W}_{2 , l} ,$$

where W₁ is a 2N₁N₂×2L block-diagonal matrix (L<N₁N₂) with two identical diagonal blocks, e.g.:

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & ⋯ & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript^{T} denotes a matrix transposition operation. Note that O₁, O₂ oversampling factors are considered for the 2D DFT matrix from which matrix B is drawn. Note that W₁ is common across all layers. W_{2,l} is a 2L×N₃ matrix, where the i^{th} column corresponds to the linear combination coefficients of the 2L beams in the i^{th} sub-band. Only the indices of the L selected columns of B may be reported, along with the oversampling index taking on O₁O₂ values. Note that W_{2,l} are independent for different layers.

In some wireless communications systems, for Type-II Port Selection codebook, only K (where K≤2N₁N₂) beamformed CSI-RS ports are utilized in downlink (DL) transmission, in order to reduce complexity. The. The K×N₃ codebook matrix per layer takes on the form

$${W}_{l} = {W}_{1}^{PS} {W}_{2 , l} .$$

Here, W₂ follows the same structure as the conventional NR Rel. 15 Type-II Codebook, and are layer specific.

$${W}_{1}^{PS}$$

is a K×2L block-diagonal matrix with two identical diagonal blocks, e.g.,

$${W}_{1}^{PS} = [ \begin{matrix}E & 0 \\ 0 & E\end{matrix} ] ,$$

and E is an

$$\frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & ⋯ & {e}_{mod ( {m}_{PS} {d}_{PS} + L - 1 , K / 2 )}^{( K / 2 )}\end{matrix} ] ,$$

where

$${e}_{i}^{( K )}$$

is a standard unit vector with a 1 at the i^{th} location. Here d_{PS} is an RRC parameter which takes on the values {1,2,3,4} under the condition d_{PS}≤min (K/2, L), whereas m_{PS} takes on the values

$$\{ 0 , … , ⌈ \frac{K}{2 {d}_{PS}} ⌉ - 1 \}$$

and is reported as part of the uplink CSI feedback overhead. W₁ is common across all layers.

For K=16, L=4 and d_{PS}=1, the 8 possible realizations of E corresponding to m_{PS}={0, 1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

NR Rel. 15 Type-I codebook is the baseline codebook for NR, with a variety of configurations. The most common utility of Rel. 15 Type-I codebook is a special case of NR Rel. 15 Type-II codebook with L=1 for RI=1, 2, wherein a phase coupling value is reported for each sub-band, e.g., W_{2,l} is 2×N₃, with the first row equal to [1, 1, . . . , 1] and the second row equal to [e^{j2πØ}^{₀}, . . . , e^{j2πØ}^{_{N3-1}}]. Under specific configurations, φ₀=φ₁ . . . =φ, e.g., wideband reporting. For RI>2 different beams are used for each pair of layers. NR Rel. 15 Type-I codebook can be depicted as a low-resolution version of NR Rel. 15 Type-II codebook with spatial beam selection per layer-pair and phase combining only.

For NR Rel. 16 Type-II codebook, some wireless communications systems consider that a gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable downlink channel estimation with high resolution for NR Rel. 16 Type-II codebook. In order to reduce the uplink feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}}} ] ,\end{matrix}$$

$${v}_{l , m} = {[ \begin{matrix}{u}_{m} & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & ⋯ & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript^{T} denotes a matrix transposition operation. Note that O₁, O₂ oversampling factors are considered for the 2D DFT matrix from which matrix B is drawn. Note that W₁ is common across all layers. W_{f} is an N₃×M matrix (M<N₃) with columns selected from a critically-sampled size-N₃ DFT matrix, as follows:

$${w}_{f , l} = [ \begin{matrix}{f}_{{k}_{0}} & {f}_{{k}_{1}} & ⋯ & {f}_{{k}_{{M}^{′} - 1}}\end{matrix} ] , 0 \leq {k}_{i} \leq {N}_{3} - 1 ,$$

$${[ \begin{matrix}1 & {e}^{- j \frac{2 π k}{{N}_{3}}} & ⋯ & {e}^{- j \frac{2 π k ( {N}_{3} - 1 )}{{N}_{3}}}\end{matrix} ]}^{T} .$$

Only the indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred as the selected Frequency Domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of ┌2βLM┐−1 coefficients (along with the indices of selected L, M DFT vectors) are reported per layer, leading to significant reduction in CSI report size, compared with reporting 2N₁N₂×N₃−1 coefficients' information.

For Type-II Port Selection codebook, only K (where K≤2N₁N₂) beamformed CSI-RS ports are utilized in downlink transmission, in order to reduce complexity. The. The K×N₃ codebook matrix per layer takes on the form:

$${W}_{l} = {W}_{1}^{PS} {\tilde{W}}_{2 , l} {W}_{f , l}^{H} .$$

Here, \tilde{W}_{2,l} and W_{f,l} follow the same structure as the conventional NR Rel. 16 Type-II Codebook, where both are layer specific. The matrix

$${W}_{1}^{PS}$$

is a K×2L block-diagonal matrix with the same structure as that in the NR Rel. 15 Type-II Port Selection Codebook.

In some wireless communications systems, Rel. 17 Type-II Port Selection codebook follows a similar structure as that of Rel. 15 and Rel. 16 port-selection codebooks, as follows:

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,l} and W_{f,l} follow the same structure as the conventional NR Rel. 16 Type-II Codebook, however M is limited to 1,2 only, with the network configuring a window of size N={2,4} for M=2. Moreover, the bitmap is reported unless β=1 and the UE reports all the coefficients for a rank up to a value of two.

Considering the CSI feedback use case, and assuming that some training samples are at a UE side node that are to be transmitted to a node at the network side. As an example, assume that there are K samples representing the largest eigenvectors associated with K different channel realizations of the environment. Note that in this example each of these samples are real-valued vectors of size m. These samples can be transmitted differently.

In a first scheme, each entry of the vectors is quantized into 2^{r} levels and then the quantized values are transferred to the other node. In this scheme, the total of K×m×r is calculated. Note that increasing r increases the amount of data that is transferred, and in return, a more accurate representation of the actual samples will be available at the entity that receives the samples.

In a second scheme, the samples correspond to conventional schemes for CSI feedback as discussed above. For example, considering the codebook design of NR Rel. 16 Type-II Codebook with certain parameters, each eigen vector can be encoded using “l” bits. Transmitting the total of l×K bits, the receiving entity can use this information to reconstruct the actual eigen vectors. Similar to the first scheme, using feedback schemes that require a higher number of feedback bits (larger l) increases the amount of data that is transferred, and in return, a more accurate representation of the actual samples will be available at the entity that receives the samples.

It should be noted that this feedback scheme is not limited to the methods discussed above (e.g., with reference to the NR Rel. 16 Type-II Codebook) and that additional extensions can be defined which uses a higher number of feedback bits.

To reduce the transfer cost, these schemes try to reduce the amount of data used for the transmission of each sample and in both schemes all K samples are transmitted to the other entity.

In the following, various techniques are discussed to try to reduce the amount of data needed for data transfer by efficiently selecting the samples that are more important to be transferred, e.g., reducing the number of transmitted samples from K to K′≤K.

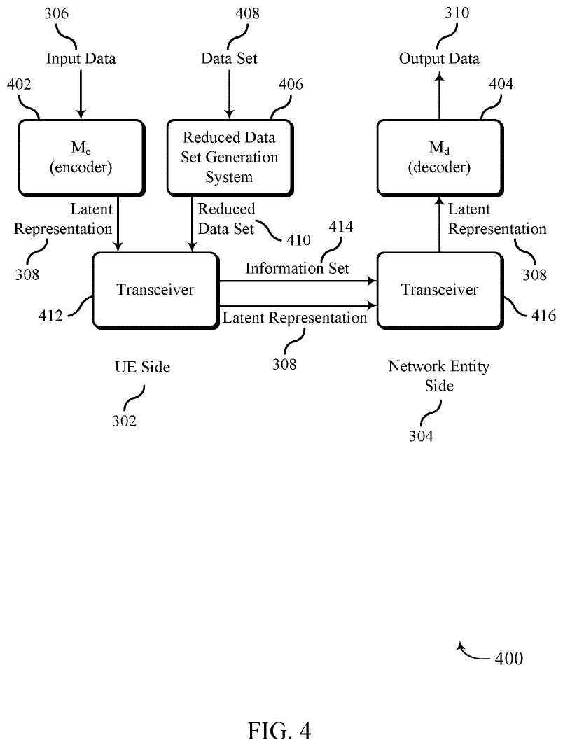

FIG. 4 illustrates an example of a wireless communications system 400 that supports efficiently transmitting a set of samples to another device in accordance with aspects of the present disclosure. The wireless communications system 400 includes a two-sided model with a UE side 302 that includes a NN-based encoder referred to as Mₑ (encoding model) 402, and a network entity side 304 that includes a NN-based decoder referred to as M_{d} (decoding model) 404. The UE side 302 also includes a reduced data set generation system 406 that receives a data set 408. The data set 408 may be generated at the UE side 302 (e.g., by a UE 104) or by another device or node. The reduced data set generation system 406 generates, based at least in part on the data set 408, a reduced data set 410. The reduced data set generation system 406 uses any of a variety of different techniques to generate the reduced data set 410 as discussed in more detail below.

The reduced data set generation system 406 provides the reduced data set 410 to a transceiver 412, which transmits a set of information 414 to a transceiver 416 at the network entity side 304. The set of information 414 may be the reduced data set 410, which can be used to, for example, train the Mₑ (encoding model) 402 and the M_{d} (decoding model) 404. The set of information 414 may also be other information, such as a model (e.g., which will generate the data set 408 or the reduced data set 410). The set of information 414 may also be transferred to one or more other nodes in addition to (or instead of) being transmitted to the network entity side 304. These one or more other nodes (e.g., other network entities) can take any of a variety of actions based on the set of information 414, such as monitoring all or part of the AI/ML model.

The Mₑ (encoding model) 402 also receives input data 306 and provides a latent representation 308 of the input data with a low number of bits (e.g., as low a number of bits as possible) to the transceiver 412. The transceiver 412 transmits the latent representation 308 to the transceiver 416, which provides the latent representation 308 to the M_{d} (decoding model) 404, which reconstructs, as output 310, the information intended to be transmitted to the network entity side 304.

Considering a two-sided model, [symbol] is used to refer to the complete model while Mₑ and M_{d} are referring to the UE side and the network entity (e.g., gNB) side of the model, respectively. It is assumed that a dataset D={(xᵢ, yᵢ), i=1, 2, . . . , K} is at one entity (e.g., one side) and is to be transferred to another entity (e.g., the other side), where xᵢ and yᵢ will represent the i^{th} input and expected output vectors of the model.

For example, D can represent the set of the largest eigenvectors of K channel realizations that are collected at the UE and are to be sent to a node at the network side to train Mₑ and M_{d}.

Additionally or alternatively, D can represent the set of the samples where yᵢ represent the largest eigenvectors of i^{th} channel measurement (collected at the UE) and xᵢ represent the latent representation of yᵢ using the encoder block, e.g., xᵢ=Mₑ(yᵢ). The dataset is transferred to a network side to train M_{d}.

In another example, Mₑ and M_{d} are previously trained. Set D consists of samples collected at the UE which is to be transmitted to another node that is responsible for monitoring the performance of the model.

In another example, a central node has received a few samples from multiple UEs and is to transmit back set D which is at least a subset of these samples to a UE so the UE can train or update its model.

One idea in the following techniques is that not all samples are equally important in generation of an AI/ML model. Some samples might be redundant or might not be very informative or have high cross-correlation considering the samples that have already been observed by the model. Additionally, a subset of the following schemes aims at reducing the redundancy in samples by removing similar samples, and instead associates a weight (or alternatively a rate-of-occurrence parameter or a probability value or a quantization thereof) to each or a group of the reported samples.

In one or more implementations input based schemes are used where it is assumed that the node with the dataset does not have access to the complete trained AI/ML model. For example, the node does not have knowledge of the two-sided model, it has access to only one part of the model, or the model has not been trained yet.

It is assumed that the node uses a function, ƒ(·), to estimate the importance of a sample with respect to the others. This function can be selected by that node itself or the node can be instructed to use a certain function.

In one or more implementations, ƒ(·) is based on the geometric properties of the input data. For example, determining a similarity metric or pairwise distance between samples of the dataset, selecting a few representative samples from each cluster and transmitting them (not transmitting samples which are very close to each other).

Additionally or alternatively, in addition to the geometric properties of the input data, ƒ(·) is based on the relation between xᵢ and yᵢ. For example, even two samples which are geometrically close by input domain will be selected for transmission if their outputs are not close to each other.

Additionally or alternatively, the node with the dataset also has access to another dataset, D′, which fully or partly represents the codebook of the dataset points used for training of the model. In such case, the node may determine the probability of observing or the occurrence of each of the samples in dataset D based on the samples in D′. This probability can be used to determine which samples should be transmitted and which one will be skipped, e.g., comparing to a threshold (e.g., samples with probability above a threshold may be discarded for reducing redundancy or samples with probability below a threshold may be discarded for increasing correlated samples). The probability of observing or the occurrence of each or a group of the samples may be signaled as part of the training data transmission.

Additionally or alternatively, ƒ(·) can be based on an NN block that has as inputs either or a combination of xᵢ and yᵢ and outputs a measure of importance for this sample. The NN block could be a discriminator NN block already trained based on the training data (e.g., training data not including the sample xᵢ and yᵢ in D) which output the probability of having a sample like the current input. Low probability samples can be good samples to be transmitted as they would be novel samples of the environment.

In the implementations discussed above, selection of the important samples was not task dependent as it was not based on the trained model.

In one or more implementations, the node has access to a model, denoted by M_{g}, and all different implementations discussed above for sample selection can be based on the latent representation of the input data, e.g., M_{g}(xᵢ) instead of xᵢ itself. M_{g} could be Mₑ or M_{d} of the two-side model or it could be a NN block that has been transmitted to the node from another node. These schemes can be referred to as latent based schemes. M_{g} can be already available at the node, or the node may receive M_{g} from another entity in the network.

A combination of one or more of the input-based and latent-based schemes can be used for sample selection as well.

In the implementations discussed above, the node may determine and transmit a weight associated with each sample as well. This weight could represent the importance of that sample in the original dataset, or alternatively the rate of observation/occurrence or probability value (or a quantization thereof) of a given sample (or a sample group).

Additionally or alternatively, the samples of the dataset D are used for constructing a generative model and instead of the actual samples, the parameters of the model are transmitted to the other node. The generative model is then used by the receiving node to generate samples.

In one or more implementations a model based scheme used where it is assumed that there is a node (a first node, e.g., a UE) with a part of an AI/ML model (e.g., the encoding part) that wants to send a set of samples to another node (a second node, e.g., a network entity such as a gNB). In contrast with the previous implementations, here it is assumed that the other part of the AI/ML model (which has been unknown to the node (first node), e.g., the decoding part of the model performed at the second node) has also become available to that node (first node) as well, e.g., it has been transferred to the node. This model, could be the actual model used at the other node (second node), or could be a simplified version of the actual model (e.g., to reduce the computational complexity). This scheme is also applicable in one sided models when the whole model is or becomes available at the node (first node) having the dataset.

Similar to the discussions above, it is assumed that the node uses a function, ƒ(·), to estimate the importance of different samples. This function can be selected by that node itself or the node can be instructed to use a certain function.

Having access to the complete model, the node can determine the output of the model for each sample in the dataset.

In one or more implementations, the function ƒ(·) can be selected as a function comparing the output of the model and the expected output to compute a loss function. Function ƒ(·) can be different in different applications, for example it could be mean square error, cross entropy, or cosine similarity. Additionally or alternatively, ƒ(·) computes the uncertainty associated with each sample of the dataset.

The output of ƒ(·) can be used to determine which samples to transmit. For instance, transmit samples which resulted to higher mean squared error (MSE) or uncertainty values (e.g., above a threshold, for example for reducing redundancy).

Additionally or alternatively, the node performs backpropagation step for each sample and determines the gradient associated with the sample. Function ƒ(·) then can be defined to select samples that have larger gradients values (e.g., above a gradient threshold).

Additionally or alternatively, function ƒ(·) will be defined to select a few samples with some weights such that the weighted average of the gradients of those samples becomes similar to the average gradient of the whole dataset.

Additionally or alternatively, the node constructs some artificial samples that the weighted average gradient of those samples has similar value to the average gradient of the whole dataset. The node then transmits the newly generated samples and potentially along with some weights to the other node.

A combination of one or more of model-based schemes and also combination of input based and model based schemes (e.g., any of the various implementations discussed above) are also possible.

Additionally or alternatively, the node may determine and transmit a weight associated with each sample as well. This weight represents the rate of observation or occurrence or probability value (or a quantization thereof) of that sample (or a sample group) in the original dataset.

Accordingly, techniques for reducing the communication cost of transferring samples of a dataset to another entity, especially when two-sided AI/ML models are deployed, are provided herein.

In one or more implementations, an input-based scheme using geometrics of the input, input/output pairs, or statistical similarity between the dataset and the training dataset is proposed.

Additionally or alternatively, a scheme based on the latent-space of the samples using at least part of the model is proposed.

Additionally or alternatively, a model-based scheme determining the importance of different samples using a loss function, the gradient associated with the samples is proposed.

Additionally or alternatively, a model-based scheme that constructs new samples which are transmitted instead of the actual samples is proposed.

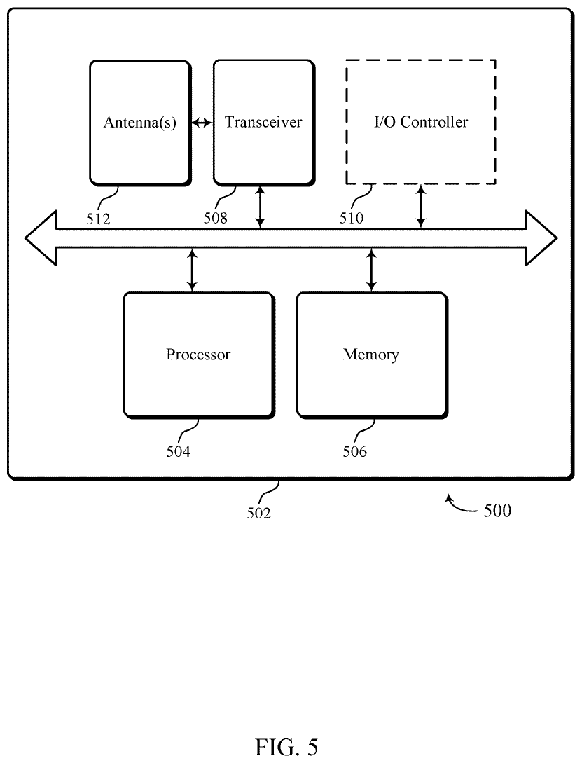

FIG. 5 illustrates an example of a block diagram 500 of a device 502 that supports efficiently transmitting a set of samples to another device in accordance with aspects of the present disclosure. The device 502 may be an example of a UE 104 as described herein. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. Processor 504 may be configured as or otherwise support to: obtain a first set of information that includes a set of samples, where each sample includes at least one of a first component and a second component, and where the first component is based at least in part on an input to an artificial intelligence/machine learning model and the second component is based at least in part on an expected output of the artificial intelligence/machine learning model; generate, using a function, a second set of information based at least in part on at least one of the first component or the second component; transmit, to a network entity, a first signaling indicating a third set of information generated based at least in part on at least one of the first set of information and the second set of information.

Additionally or alternatively, the processor 504 may be configured to or otherwise support: where the samples in the set of samples are based at least in part on a channel data representation during a first time-frequency-space region; where the processor is further configured to cause the apparatus to receive, from another device, a second signaling indicating the first set of information; where the function is received from or configured by another device; where the function assigns an importance value and a weight to samples of at least a representation of the first set of information and where the processor is further configured to cause the apparatus to generate the second set of information based on whether the importance value is larger than a predetermined threshold; where the function is based on at least geometric properties of at least one of the first component or the second component; where the function is based on at least joint geometric properties of the first component and the second component; where the function is based on at least a fourth set of information that includes a set of samples of at least one of the first component and the second component where the first component and the second component are based on an input and an expected output of an additional artificial intelligence/machine learning model; where the function is based on a statistical similarity of the samples of the first set of information and the fourth set of information; where the fourth set of information includes a set of channel data representations during a time-frequency-space region and are used to train the artificial intelligence/machine learning model; where the function is based on a neural network block that is determined based on a set of parameters including a structure of the neural network or weights of the neural network where the output of the neural network block is used to determine at least the importance value and the weight of the samples; where an input of the neural network block is based on at least one of the first component or the second component; where an output of the neural network block is based on at least one of the first component or the second component; where the processor is further configured to cause the apparatus to receive, from another device, a second signaling indicating the set of parameters; where the representation of the first set of information is based on at least an embedding neural network block defined based on a set of information related to a structure and weights of the neural network block; where the processor is further configured to cause the apparatus to receive, from another device, a second signaling indicating the set of information related to the structure and weights of the neural network block; where samples in the second set of information include at least a subset of the first set of information and weights associated with samples of the first set of information; where the third set of information includes an additional set of samples, where each sample in the additional set of samples includes at least one of the first component, the second component, and a third component, and where the third component represents a weight of the sample; where the third set of information includes information related to a model, and where the model is determined to generate samples with similar statistics to at least one of the first set of information or the second set of information; where the model is a neural network block and the third set of information includes information related to at least one of a structure and weights of the neural network block; where the processor is further configured to cause the apparatus to determine a first neural network block and a second neural network block representing an encoding and a decoding side of a two-sided model; where the processor is further configured to cause the apparatus to receive, from another device, a second signaling indicating parameters used for determination of at least the first neural network block and the second neural network block; where the function assigns an importance value and a weight to samples of the first set of information and where the processor is further configured to cause the apparatus to generate the second set of information based at least in part on whether the importance value is larger than a predetermined threshold; where the function is based on at least a difference or gradient associated with the second component and an output of the two-sided model based on the first component; where the function generates samples of the second set of information including at least one of the first component, the second component, and associated weights such that a weighted gradient average corresponding to the generated samples is close to an average gradient corresponding to samples of the first set of information.

For example, the processor 504 may support wireless communication at the device 502 in accordance with examples as disclosed herein. Processor 504 may be configured as or otherwise support a means for obtaining a first set of information that includes a set of samples, where each sample includes at least one of a first component and a second component, and where the first component is based at least in part on an input to an artificial intelligence/machine learning model and the second component is based at least in part on an expected output of the artificial intelligence/machine learning model; generating, using a function, a second set of information based at least in part on at least one of the first component or the second component; and transmitting, to a network entity, a first signaling indicating a third set of information generated based at least in part on at least one of the first set of information and the second set of information.

Additionally or alternatively, the processor 504 may be configured to or otherwise support: where the samples in the set of samples are based at least in part on a channel data representation during a first time-frequency-space region; further including receiving, from another device, a second signaling indicating the first set of information; where the function is received from or configured by another device; where the function assigns an importance value and a weight to samples of at least a representation of the first set of information and the method further including generating the second set of information based on whether the importance value is larger than a predetermined threshold; where the function is based on at least geometric properties of at least one of the first component or the second component; where the function is based on at least joint geometric properties of the first component and the second component; where the function is based on at least a fourth set of information that includes a set of samples of at least one of the first component and the second component where the first component and the second component are based on an input and an expected output of an additional artificial intelligence/machine learning model; where the function is based on a statistical similarity of the samples of the first set of information and the fourth set of information; where the fourth set of information includes a set of channel data representations during a time-frequency-space region and are used to train the artificial intelligence/machine learning model; where the function is based on a neural network block that is determined based on a set of parameters including a structure of the neural network or weights of the neural network where the output of the neural network block is used to determine at least the importance value and the weight of the samples; where an input of the neural network block is based on at least one of the first component or the second component; where an output of the neural network block is based on at least one of the first component or the second component; further including receiving, from another device, a second signaling indicating the set of parameters; where the representation of the first set of information is based on at least an embedding neural network block defined based on a set of information related to a structure and weights of the neural network block; further including receiving, from another device, a second signaling indicating the set of information related to the structure and weights of the neural network block; where samples in the second set of information include at least a subset of the first set of information and weights associated with samples of the first set of information; where the third set of information includes an additional set of samples, where each sample in the additional set of samples includes at least one of the first component, the second component, and a third component, and where the third component represents a weight of the sample; where the third set of information includes information related to a model, and where the model is determined to generate samples with similar statistics to at least one of the first set of information or the second set of information; where the model is a neural network block and the third set of information includes information related to at least one of a structure and weights of the neural network block; further including determining a first neural network block and a second neural network block representing an encoding and a decoding side of a two-sided model; further including receiving, from another device, a second signaling indicating parameters used for determination of at least the first neural network block and the second neural network block; where the function assigns an importance value and a weight to samples of the first set of information and further including generating the second set of information based at least in part on whether the importance value is larger than a predetermined threshold; where the function is based on at least a difference or gradient associated with the second component and an output of the two-sided model based on the first component; where the function generates samples of the second set of information including at least one of the first component, the second component, and associated weights such that a weighted gradient average corresponding to the generated samples is close to an average gradient corresponding to samples of the first set of information.

The processor 504 of the device 502, such as a UE 104, may support wireless communication in accordance with examples as disclosed herein. The processor 504 includes at least one controller coupled with at least one memory, and is configured to or operable to cause the processor to obtain a first set of information that includes a set of samples, wherein each sample includes at least one of a first component and a second component, and wherein the first component is based at least in part on an input to an artificial intelligence/machine learning model and the second component is based at least in part on an expected output of the artificial intelligence/machine learning model; generate, using a function, a second set of information based at least in part on at least one of the first component or the second component; transmit, to a network entity, a first signaling indicating a third set of information generated based at least in part on at least one of the first set of information and the second set of information.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device 502. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

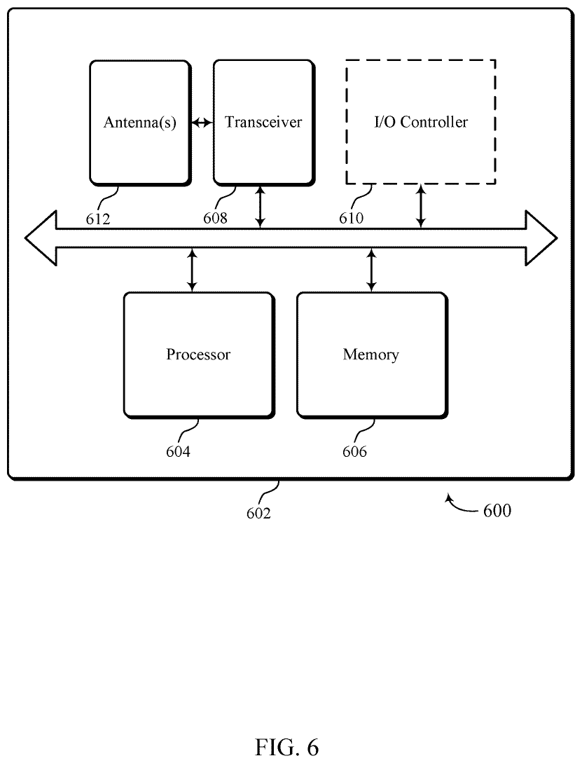

FIG. 6 illustrates an example of a block diagram 600 of a device 602 that supports efficiently transmitting a set of samples to another device in accordance with aspects of the present disclosure. The device 602 may be an example of a network entity 102 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. Processor 604 may be configured as or otherwise support to: receive, from a first device, a first signaling indicating a first set of information that includes a set of samples, where each sample includes at least one of a first component, a second component, and a third component, and where the first component and the second component are based on an input and an expected output of an artificial intelligence/machine learning model and the third component represents a weight of the sample; generate a first set of parameters for at least a first neural network based on the first set of information, where the first set of parameters includes a structure of the first neural network or weights of the first neural network.

Additionally or alternatively, the processor 604 may be configured to or otherwise support: where the samples in the set of samples are based at least in part on a channel data representation during a first time-frequency-space region; where a function used to determine the first set of information assigns an importance value and a weight to samples of at least a representation of a second set of information; where a function used to determine the first set of information is based on at least geometric properties of at least one of the first component or the second component; where a function used to determine the first set of information is based on at least joint geometric properties of the first component and the second component; where a function used to determine the first set of information is based on at least a second set of information that includes a set of samples of at least one of the first component and the second component where the first component and the second component are based on an input and an expected output of an additional artificial intelligence/machine learning model; where a function used to determine the first set of information is based on a statistical similarity of the samples of the first set of information and the second set of information; where the second set of information includes a set of channel data representations during a time-frequency-space region and are used to train the artificial intelligence/machine learning model; where a function used to determine the first set of information is based on a neural network block that is determined based on a second set of parameters including a structure of the neural network or weights of the neural network where the output of the neural network block is used to determine at least an importance value and the weight of the samples; where an input of the neural network block is based on at least one of the first component or the second component; where an output of the neural network block is based on at least one of the first component or the second component.

For example, the processor 604 may support wireless communication at the device 602 in accordance with examples as disclosed herein. Processor 604 may be configured as or otherwise support a means for receiving, from a first device, a first signaling indicating a first set of information that includes a set of samples, where each sample includes at least one of a first component, a second component, and a third component, and where the first component and the second component are based on an input and an expected output of an artificial intelligence/machine learning model and the third component represents a weight of the sample; and generating a first set of parameters for at least a first neural network based on the first set of information, where the first set of parameters includes a structure of the first neural network or weights of the first neural network.

Additionally or alternatively, the processor 604 may be configured to or otherwise support: where the samples in the set of samples are based at least in part on a channel data representation during a first time-frequency-space region; where a function used to determine the first set of information assigns an importance value and a weight to samples of at least a representation of a second set of information; where a function used to determine the first set of information is based on at least geometric properties of at least one of the first component or the second component; where a function used to determine the first set of information is based on at least joint geometric properties of the first component and the second component; where a function used to determine the first set of information is based on at least a second set of information that includes a set of samples of at least one of the first component and the second component where the first component and the second component are based on an input and an expected output of an additional artificial intelligence/machine learning model; where a function used to determine the first set of information is based on a statistical similarity of the samples of the first set of information and the second set of information; where the second set of information includes a set of channel data representations during a time-frequency-space region and are used to train the artificial intelligence/machine learning model; where a function used to determine the first set of information is based on a neural network block that is determined based on a second set of parameters including a structure of the neural network or weights of the neural network where the output of the neural network block is used to determine at least an importance value and the weight of the samples; where an input of the neural network block is based on at least one of the first component or the second component; where an output of the neural network block is based on at least one of the first component or the second component.

The processor 604 of the device 602, such as a network entity 102, may support wireless communication in accordance with examples as disclosed herein. The processor 604 includes at least one controller coupled with at least one memory, and is configured to or operable to cause the processor to receive, from a first device, a first signaling indicating a first set of information that includes a set of samples, wherein each sample includes at least one of a first component, a second component, and a third component, and wherein the first component and the second component are based on an input and an expected output of an artificial intelligence/machine learning model and the third component represents a weight of the sample; generate a first set of parameters for at least a first neural network based on the first set of information, wherein the first set of parameters includes a structure of the first neural network or weights of the first neural network.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device 602. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

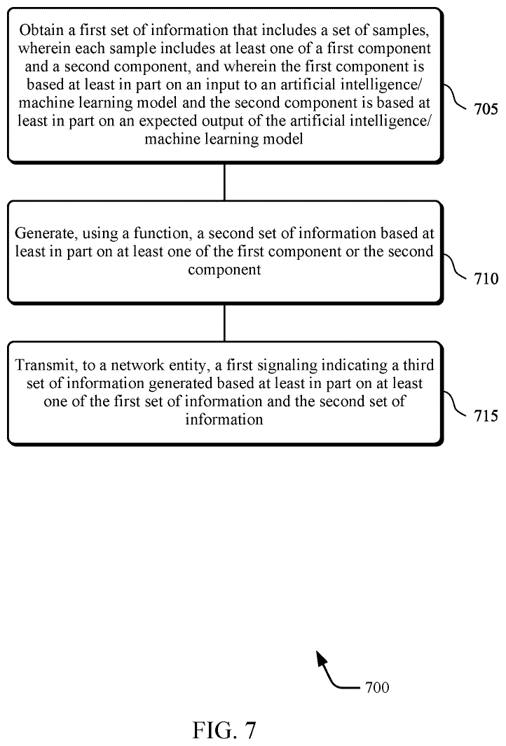

FIG. 7 illustrates a flowchart of a method 700 that supports efficiently transmitting a set of samples to another device in accordance with aspects of the present disclosure. The operations of the method 700 may be implemented by a device or its components as described herein. For example, the operations of the method 700 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 705, the method may include obtaining a first set of information that includes a set of samples, wherein each sample includes at least one of a first component and a second component, and wherein the first component is based at least in part on an input to an artificial intelligence/machine learning model and the second component is based at least in part on an expected output of the artificial intelligence/machine learning model. The operations of 705 may be performed in accordance with examples as described herein. In some implementations, aspects of the operations of 705 may be performed by a device as described with reference to FIG. 1.

At 710, the method may include generating, using a function, a second set of information based at least in part on at least one of the first component or the second component. The operations of 710 may be performed in accordance with examples as described herein. In some implementations, aspects of the operations of 710 may be performed by a device as described with reference to FIG. 1.

At 715, the method may include transmitting, to a network entity, a first signaling indicating a third set of information generated based at least in part on at least one of the first set of information and the second set of information. The operations of 715 may be performed in accordance with examples as described herein. In some implementations, aspects of the operations of 715 may be performed by a device as described with reference to FIG. 1.

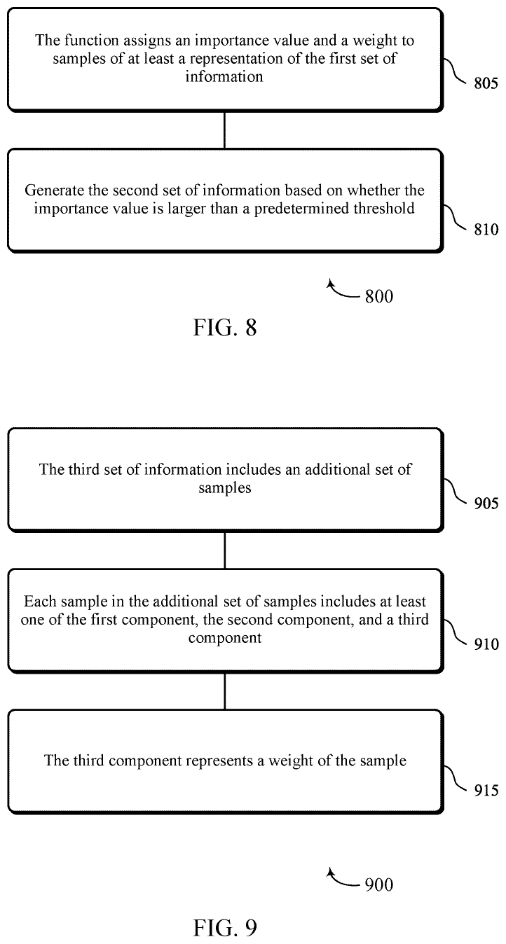

FIG. 8 illustrates a flowchart of a method 800 that supports efficiently transmitting a set of samples to another device in accordance with aspects of the present disclosure. The operations of the method 800 may be implemented by a device or its components as described herein. For example, the operations of the method 800 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 805, the method may include the function assigning an importance value and a weight to samples of at least a representation of the first set of information. The operations of 805 may be performed in accordance with examples as described herein. In some implementations, aspects of the operations of 805 may be performed by a device as described with reference to FIG. 1.

At 810, the method may include generating the second set of information based on whether the importance value is larger than a predetermined threshold. The operations of 810 may be performed in accordance with examples as described herein. In some implementations, aspects of the operations of 810 may be performed by a device as described with reference to FIG. 1.

FIG. 9 illustrates a flowchart of a method 900 that supports efficiently transmitting a set of samples to another device in accordance with aspects of the present disclosure. The operations of the method 900 may be implemented by a device or its components as described herein. For example, the operations of the method 900 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 905, the method may include the third set of information includes an additional set of samples. The operations of 905 may be performed in accordance with examples as described herein. In some implementations, aspects of the operations of 905 may be performed by a device as described with reference to FIG. 1.

At 910, the method may include each sample in the additional set of samples includes at least one of the first component, the second component, and a third component. The operations of 910 may be performed in accordance with examples as described herein. In some implementations, aspects of the operations of 910 may be performed by a device as described with reference to FIG. 1.

At 915, the method may include the third component represents a weight of the sample. The operations of 915 may be performed in accordance with examples as described herein. In some implementations, aspects of the operations of 915 may be performed by a device as described with reference to FIG. 1.

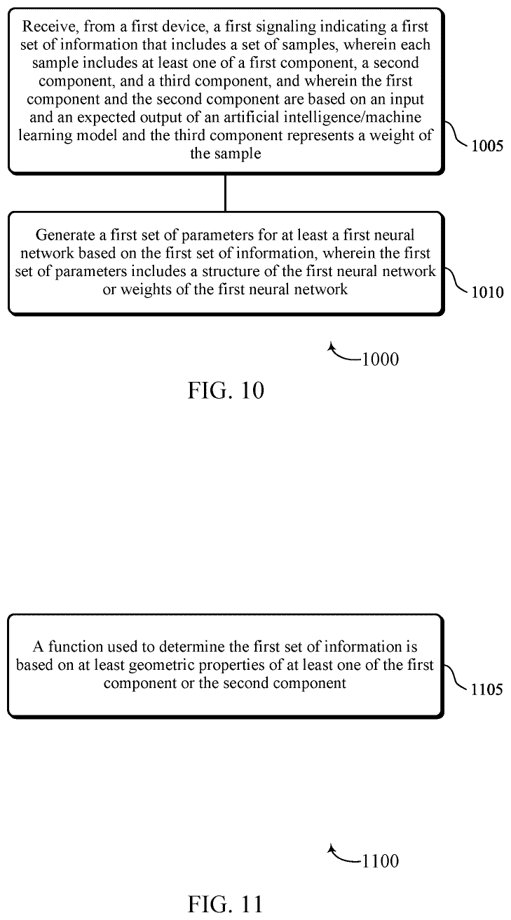

FIG. 10 illustrates a flowchart of a method 1000 that supports efficiently transmitting a set of samples to another device in accordance with aspects of the present disclosure. The operations of the method 1000 may be implemented by a device or its components as described herein. For example, the operations of the method 1000 may be performed by a network entity 102 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1005, the method may include receiving, from a first device, a first signaling indicating a first set of information that includes a set of samples, wherein each sample includes at least one of a first component, a second component, and a third component, and wherein the first component and the second component are based on an input and an expected output of an artificial intelligence/machine learning model and the third component represents a weight of the sample. The operations of 1005 may be performed in accordance with examples as described herein. In some implementations, aspects of the operations of 1005 may be performed by a device as described with reference to FIG. 1.

At 1010, the method may include generating a first set of parameters for at least a first neural network based on the first set of information, wherein the first set of parameters includes a structure of the first neural network or weights of the first neural network. The operations of 1010 may be performed in accordance with examples as described herein. In some implementations, aspects of the operations of 1010 may be performed by a device as described with reference to FIG. 1.

FIG. 11 illustrates a flowchart of a method 1100 that supports efficiently transmitting a set of samples to another device in accordance with aspects of the present disclosure. The operations of the method 1100 may be implemented by a device or its components as described herein. For example, the operations of the method 1100 may be performed by a network entity 102 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1105, the method may include a function used to determine the first set of information is based on at least geometric properties of at least one of the first component or the second component. The operations of 1105 may be performed in accordance with examples as described herein. In some implementations, aspects of the operations of 1105 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
obtain a first set of information that includes a set of samples, wherein each sample includes at least one of a first component and a second component, and wherein the first component is based at least in part on an input to an artificial intelligence/machine learning (AI/ML) model and the second component is based at least in part on an expected output of the AI/ML model;
generate, using a function, a second set of information based at least in part on at least one of the first component or the second component;
transmit, to a network entity, a first signaling indicating a third set of information generated based at least in part on at least one of the first set of information and the second set of information.

2. The UE of claim 1, wherein the samples in the set of samples are based at least in part on a channel data representation during a first time-frequency-space region.

3. The UE of claim 1, wherein the at least one processor is further operable to cause the UE to receive, from another device, a second signaling indicating the first set of information.

4. The UE of claim 1, wherein the function is received from or configured by another device.

5. The UE of claim 1, wherein the function assigns an importance value and a weight to samples of at least a representation of the first set of information and wherein the at least one processor is further operable to cause the UE to generate the second set of information based on whether the importance value is larger than a predetermined threshold.

6. The UE of claim 1, wherein the function is based on at least geometric properties of at least one of the first component or the second component.

7. The UE of claim 1, wherein the function is based on at least joint geometric properties of the first component and the second component.

8. The UE of claim 1, wherein the function is based on at least a fourth set of information that includes a set of samples of at least one of the first component and the second component where the first component and the second component are based on an input and an expected output of an additional AI/ML model, and the function is based on a statistical similarity of the samples of the first set of information and the fourth set of information.

9. The UE of claim 1, wherein the function is based on at least a fourth set of information that includes a set of samples of at least one of the first component and the second component where the first component and the second component are based on an input and an expected output of an additional AI/ML model, and the fourth set of information includes a set of channel data representations during a time-frequency-space region and are used to train the AI/ML model.

10. The UE of claim 5, wherein the function is based on a neural network block that is determined based on a set of parameters including a structure of the neural network or weights of the neural network where the output of the neural network block is used to determine at least the importance value and the weight of the samples.

11. The UE of claim 10, wherein the at least one processor is further operable to cause the UE to receive, from another device, a second signaling indicating the set of parameters.

12. The UE of claim 5, wherein the representation of the first set of information is based on at least an embedding neural network block defined based on a set of information related to a structure and weights of the neural network block, and wherein the at least one processor is further operable to cause the UE to receive, from another device, a second signaling indicating the set of information related to the structure and weights of the neural network block.

13. The UE of claim 1, wherein samples in the second set of information include at least a subset of the first set of information and weights associated with samples of the first set of information.

14. The UE of claim 1, wherein the third set of information includes an additional set of samples, wherein each sample in the additional set of samples includes at least one of the first component, the second component, and a third component, and wherein the third component represents a weight of the sample.

15. The UE of claim 1, wherein the third set of information includes information related to a model, wherein the model is determined to generate samples with similar statistics to at least one of the first set of information or the second set of information, wherein the model is a neural network block, and the third set of information includes information related to at least one of a structure and weights of the neural network block.

16. The UE of claim 1, wherein the at least one processor is further operable to cause the UE to determine a first neural network block and a second neural network block representing an encoding and a decoding side of a two-sided model.

17. (canceled)

18. A base station for wireless communication, comprising:
at least one memory; and
at least one processor coupled with the at least one memory and operable to cause the base station to:
receive, from a first device, a first signaling indicating a first set of information that includes a set of samples, wherein each sample includes at least one of a first component, a second component, and a third component, and wherein the first component and the second component are based on an input and an expected output of an artificial intelligence/machine learning model (AI/ML) and the third component represents a weight of the sample;
generate a first set of parameters for at least a first neural network based on the first set of information, wherein the first set of parameters includes a structure of the first neural network or weights of the first neural network.

19. A method performed by a user equipment (UE), the method comprising:
obtaining a first set of information that includes a set of samples, wherein each sample includes at least one of a first component and a second component, and wherein the first component is based at least in part on an input to an artificial intelligence/machine learning (AI/ML) model and the second component is based at least in part on an expected output of the AI/ML model;
generating, using a function, a second set of information based at least in part on at least one of the first component or the second component; and
transmitting, to a network entity, a first signaling indicating a third set of information generated based at least in part on at least one of the first set of information and the second set of information.

20. (canceled)

21. The method of claim 19, wherein the samples in the set of samples are based at least in part on a channel data representation during a first time-frequency-space region.

22. A method performed by a base station the method comprising:
receiving, from a first device, a first signaling indicating a first set of information that includes a set of samples, wherein each sample includes at least one of a first component, a second component, and a third component, and wherein the first component and the second component are based on an input and an expected output of an artificial intelligence/machine learning (AI/ML) model and the third component represents a weight of the sample; and
generating a first set of parameters for at least a first neural network based on the first set of information, wherein the first set of parameters includes a structure of the first neural network or weights of the first neural network.
